(19) United States
(12) Patent Application Publication
(10) Pub. No.: US 2005/0242275 A1
(43) Pub. Date: Nov. 3, 2005

(54) Method for generating neutrally charged stable compound particles beyond the range of the first family of matter

(76) Inventor: Arnold Lasky, Brooklyn, NY (US)

Correspondence Address: OSTRAGER CHONG FLAHERTY & BROITMAN PC, 250 PARK AVENUE, SUITE 825, NEW YORK, NY, 10177, US

(21) Appl. No.: 11/045,465

(22) Filed: Jan. 27, 2005

Related U.S. Application Data
(63) Continuation-in-part of application No. 10/279,618, filed on Oct. 24, 2002, now abandoned.

(51) Int. Cl. H01S 3/00; H05H 3/02

(52) U.S. Cl. 250/251

(57) ABSTRACT

A method for generating neutrally charged stable compound particles employing a particle accelerator. The observation of a proportional relationship between the rest masses of all three families of matter led to a threefold extension of the periodic table of the elements, from the first family to the other two, and to the discovery of an energy well of fundamental particles (quarks/leptons) that is centered on the Z⁰ boson, similar to that of binding energies centered on iron 56. This led to an explanation for hadron perpetuity, and to the discovery of the mechanism that governs the transformation of hadrons of lower mass (protons/neutrons) to those of higher mass (omega minus, et al). This, in turn, led to conclusions about the role of weak bosons in matter/antimatter transformations, and to the controversial proposition that entropy, a universal condition of the expanding universe, is transposed to its antithetical counterpart, antropy, in the contracting environments of a neutron stellar core or black hole.

### RELATED APPLICATION

This application claims priority from U.S. application Ser. No. 10/279,618 filed on Oct. 24, 2002, the disclosures of which are incorporated herein by reference.

### BACKGROUND OF THE INVENTION

Every first family composite particle has a more massive counterpart, with equivalent properties, in each of the other families of matter.

To achieve the maximum longevity of any hadron, the energy range of the ambient background must be maintained within the equivalent rest mass range of that hadron's family.

An intermediate vector boson, as a particle, is incapable of mediating any transformation that permits the transformed particle to acquire a characteristic prohibited to intermediate vector bosons.

Fundamental particle formation (quark/lepton/weak boson) favors fusion below the rest mass of the Z⁰ boson, and fission above the rest mass of the Z⁰ boson.

### BRIEF SUMMARY OF THE INVENTION

The above concepts have general application to studies of cosmic rays, supernovae, quasars, gamma ray bursters, the “great attractor” and to the expansion of the observable universe, and have practical application in the manufacture and storage of antimatter.

Present efforts to produce and/or store antimatter include the creation of proton/antiproton and/or electron/positron particles in particle accelerators. These ions must be manufactured, separated, and held in magnetic traps. This presents severe limitations on the ability to concentrate these ions because, inter alia, they can only be made in dilute quantities during any finite interval, and because they must be stored in dilute quantities due to the mutual repulsion of the constituent plasma components. It also presents severe limitations on the magnetic storage of these ions because of the inherent problem of destructive particle leakage into the ambient matter environment. Attempts at the manufacture of atomic/molecular antimatter have only compounded the situation because neutral anti atoms cannot be magnetically restrained, leading to their rapid annihilation through contact with the (matter) accelerator infrastructure.

A particle accelerator can be finely tuned to operate at the discrete energies attendant to the creation of composite boson/Fermion particles a/k/a bosions (set forth with greater specificity in the chapters entitled THE EMPEROR'S BOSE—FIRST LIGHT and A BRIDGE OVER TROUBLED ETHERS). One skilled in the art of particle accelerator operation would be capable of tuning the accelerator to a discrete energy level attendant to the creation of neutrally charged stable compound particles. By way of background, a description of a method of tuning a particle accelerator by using the ²⁷Al+p→²⁸Si* reaction is described in an article entitled “Calibration of a 1.7 MV Pelletron Accelerator at the University of Florida” written by Ralph Kelly, Department of Physics, University of Florida (hereafter, “Kelly article”).

Bosions have the advantage of being stable and neutrally charged particles. Each kind of bosion can be manufactured, at its specific energy level, out of first family ions, in a sufficiently powerful magnetic particle accelerator. More importantly, because they are neutrally charged, bosions rapidly leave the ionic particle stream, whence they can be gravitationally (or otherwise) separated and collected by virtue of their extreme rest mass vis-a-vis ordinary first family matter. The most likely bosion to be collected first is the least massive, the theation (approximately 94.5 GeV), consisting of a negative theta− bound to the positive pole of the W boson.

Bosions represent stable forms of potential antimatter, to being transformed into unstable particles of matter/antimatter, by controlled collisional (or otherwise) decay. Decay occurs when the binding energy is broken between the constituent intermediate vector bosons and the third family hadrons of a particular bosion. Upon decay, the available rest mass of the bosion components annihilate into kinetic energy, at the conversion rate of 100%.

Bosion particles represent a practical way of safely accumulating, storing, and utilizing sufficient quantities of antimatter fuel for the efficient propulsion of interplanetary (and beyond) vehicles; concentrated quantities of explosives to be used in appropriate commercial applications and virtually unlimited military applications; and as individual projectiles to be used in particle accelerators that may, or may not, be electromagnetically driven.

### BRIEF DESCRIPTION OF THE DRAWINGS

FIG. 1 shows a massive sphere of matter/bosons, composed of concentric circles that each represent the rest mass/energy value of a corresponding hadron or intermediate vector boson. Only massive particles which have a whole number charge of +1, −1, or 0 are included, with rest mass values rounded off to the nearest 0.2 GeV.

FIG. 2 lists the rest masses of all of the known fundamental particles in the Standard Model, and of those known composite particles, which are important for our purposes, as well as of certain postulated composite particles.

### DETAILED DESCRIPTION OF THE INVENTION

It is widely agreed, although by no means certain, that only three families of matter exist in the accepted theory of elementary particles and forces, the Standard Model. The Standard Model is a quantum field theory, with a distinct field being assigned to each particle and force, and where disturbances in these fields propagate energy and momentum. Elementary particles are disturbances in these fields consisting of discrete packets, or quanta, of energy. For example, the photon is the quantum particle of the electromagnetic field, and the proton is the quantum particle of the proton field.

The most recognized members of the first family are the baryons, consisting of the proton (charge +1), the neutron (charge 0), and the electron (charge −1). They are the constituent particles, which comprise the atoms and molecules of ordinary matter. In addition to these is their less well-known sibling, the electron neutrino. The electron and the electron neutrino constitute the leptons, one of only two kinds of fundamental particles of ordinary matter in the Standard Model. The other fundamental particle of ordinary matter is the quark, of which there are two in the first family, the up and the down. All of the above particles have counterparts in the second and third families, each with similar properties, but with progressively higher rest masses. Second and third family matter can be thought of as extraordinary matter.

For our purposes, the three varieties of neutrino from each family can be considered as a class, which we shall call the neutronic leptons. The class consists of the first family electron neutrino (the electrino) and the electron antineutrino (the antielectrino or positrino); the second family muon neutrino, which we shall call the muino, and the muon antineutrino (the antimuino); finally, the third family tau neutrino, which we shall call the tauino, and the tau anti neutrino (the antitauino). All neutronic leptons possess an electromagnetic charge of zero.

Combinations of quarks form the hadrons, which, in the first family, are the stable proton (one down and two up quarks) and the relatively stable neutron (one up and two down quarks). Other known hadrons are observationally unstable, and include the lambda (one up, one down, and one strange quark), and the omega− (three strange quarks). All quarks, regardless of family affiliation, have a fractional charge that is one third or two thirds of the electron, and possess an electromagnetic charge that is either positive or negative.

There is no first family analogue (three down quarks) of the second family omega− (three strange quarks), with a net charge of −1, because of the Coulomb force, which electromagnetically resists combinations of particles with the same electric charge. Apparently, the Coulomb force is not sufficiently strong at the energy level of the second family to prevent such a combination. It can be concluded that the Coulomb force is not a factor in the creation of hadrons with rest mass energies beyond the first family. Hadrons with three up quarks having +⅔ charge, or with three charm quarks, or with three top quarks, are prohibited because they would have a net electromagnetic charge of +2.

It was first proposed by Arnold R. Bodner, in 1971, that a new form of stable matter, that is composed of hadrons which incorporate strange quarks, might exist within stars. Roughly fifteen years later, Edward H. Farhi and Robert L. Jaffe coined the phrase “strangelets” to describe this postulated state of matter. Were this concept a true reflection of the real universe, the implications would be profound. Unfortunately, many theoretical and experimental physicists have since labored mightily to confirm the existence of strange matter, to no avail. For certain quantum mechanical reasons, it was assumed that this new form of matter consisted of combinations of up, down, and strange quarks within hadrons composed of more than three constituent quarks. In other words, there was thought to be no limit to the absolute size of a nucleus incorporating strange quarks, nor to the number of quarks incorporated within each such nucleus.

It was further assumed that, once formed in stars, strangelet material could have somehow migrated to Earth. They were prospecting for something called quark nuggets, but never found the mine. Perhaps they were just looking in the wrong place because strangelets are configured in a manner other than conjectured, and/or because strangelets are incapable of migration due to the circumstances of their birth.

The Applicant would like to explore the proposition that hadronic combinations of second, and/or third family quarks exist as stable nuclei that share similarities with the first family, including hadron size and quark number. Such hadrons would include combinations of one up and two strange quarks, let us call it the lambda “u”; one strange and two up quarks, let us call it the lambda “s”; one charm and two strange quarks, analogous to the neutron, let us call it the seutron; and one strange and two charm quarks, analogous to the proton, let us call it the chroton. For reasons that will become clear, charm quarks are not permitted to combine with up or down quarks in the cores of stars, but may do so in particle accelerators or during atmospheric collisions.

These known and postulated hadrons are composed, partly or entirely, of second family quarks, and are unstable at the rest mass/energy range of the first family of matter, about 1 GeV to 0 GeV. That is, they spontaneously decay into less massive particles while within the energy range of the first family. There should also exist third family counterparts of at least some of these same hadrons.

All of the above known and postulated matter particles have an antimatter twin, opposite in charge, but identical in all other properties. Combinations of quarks and antiquarks comprise the mesons, which are also unstable because matter and antimatter annihilate themselves. Our present day universe appears to consist of matter only, except for the brief existence of antimatter created, and then annihilated, in high energy collisions, which take place in particle accelerators or in the atmosphere.

Other than the protons and the leptons, which apparently never decay, all of the above particles have a limited lifetime, except for the neutronic leptons. It has not yet been definitely proven that neutrinos posses mass. However, we are restricted in the observation of these short-lived particles to conditions that exist, during particle collisions, at the energies and densities existing on the Earth. In isolation, even the neutron decays in less than fifteen minutes, unless it is combined with a proton, or is incorporated into a neutron star. Yet, a neutron decays into an electron, a proton, and an antielectrino, all eternal.

Eternal protons and electrons (and, under certain conditions, neutrons) have in common electric charges of the whole numbers +1, −1, or 0, whereas most other particles have fractional charges. The fact that all other hadrons and all mesons are not eternal, even though they too have whole charge numbers, can be distinguished. The shortness of the lifetime of a meson can be explained because it is composed of matter and antimatter, which quickly annihilate one another, whereas the brevity of the other hadrons may be just an artifact of earthly energies and densities. That is to say, at constant rest mass energies and densities which are too high for protons and neutrons to exist, the Applicant proposes that certain, if not all, other hadrons also enjoy perpetuity.

We have observed the decay of the neutron in the laboratory, and we can imagine the reversal of that process. It is undisputed that protons and electrons do not exist as independent particles in the core of a neutron star, without directly sampling its physical content or taking its spectrum, because that is predicted by quantum theory. Although the collapse of a neutron star has never been directly observed, nor its consequences certified by theory, the considered result of such a collapse is the direct emergence of a black hole. The absence of any known stellar structure that could retard such a result in a transneutron star is not proof of such absence.

Therefore, one may postulate stellar structures based upon the eternal lifetimes of particles composed partly, or entirely, of second and/or third family quarks, in extreme environments of constant high energy and density, provided that all physical laws are obeyed. Such environments must exist in collapsed bodies more massive than a neutron star, and should ha′/e existed in the era immediately following the Big Bang. Let us call that era, which continues to the present day, the expansion.

We can extrapolate what the characteristics of these eternal particles would be in such extreme environments, comparing them to the well known characteristics of their first family counterparts, while still observing the accepted principles of physics. For instance, protons and electrons (and their antimatter twins) are routinely created in particle accelerators, out of pure energy, when discrete energy densities are briefly achieved. Such “artificial” particles exhibit the same properties as naturally occurring ones, e.g.: the ability to combine into ordinary atoms or anti-atoms, as the case may be. These man-made protons and electrons are also eternal, and, more importantly, they come into being out of whole cloth, as it were. That is, the manufactured proton is not assembled from individual quarks that were created first and then combined later. Individual quarks have never been directly observed in isolation.

### The Three Legged Table

Let us now explore some ramifications of being an “extended” (second and/or third) family member within the Standard Model. To be consistent, the properties of any specific kind of particle in one family, including its charge, spin, and spectrum, should correspond or relate to that of its respective counterparts in the other two families. Therefore, utilizing the generally recognized properties of first family protons and neutrons (composed of the up and the down quarks) as a model, we should be able to project similar properties to the respective hadrons of the other two families, factoring in the specific rest mass of each such other particle.

The up quark has a fractional charge of +⅔ with a rest mass of approximately 0.3 billion electric volts (GeV). The down quark has a fractional charge of −⅓ and is also approximately 0.3 GeV (it is slightly more massive than the up quark). Correspondingly, the quarks of the second family are the charm, with a fractional charge of +⅔ and a rest mass of 1.5 GeV, and the strange, charge −⅓ and 0.5 GeV, respectively. The third family's quarks are the top, charge +⅔ at approximately 175.5 GeV, and the bottom, charge −⅓at 4.5 GeV, respectively.

Pursuant to the Heisenberg Uncertainty Principle, the more massive a particle, the shorter its lifetime, and the more uncertain Its specifiC mass. The top quark is so massive, and its lifetime so short, that its specific rest mass can best be described as an average 01 many measurements centering on a value of around 175 GeV. For reasons that will be explained later, the Applicant has assigned 175.5 GeV as the rest mass value for the top quark because that is a multiple (39) of the rest mass value 01 the bottom quark, rounded off at 4.5 GeV. Since the bottom quark is less massive than the top quark, it Is more amenable to accurate calibration. It is advised that the bottom quark is the benchmark from which the rest mass values 01 hadrons, quarks and bosons will be computed and then rounded off, eg: the proton (1 GeV) plus the chroton (3.5 GeV) equals the bottom quark (45 GeV): or the strange quark at 5 GeV×9=45 GeV, or the ZO at 90 GeV=20×45 GeV.

No physical laws would necessarily be violated if, in an environment with a constant energy/density of 3.5 GeV, two charm quarks and one strange quark were to form a long-lived second family hadron, corresponding to the proton, which we shall call a chroton (Applicant's choice), or for two strange quarks and one charm quark to form a seutron (Applicant's choice), corresponding to the neutron, at a constant energy/density of 2.5 GeV. There should also exist a third family equivalent of the second family omega−, with three bottom quarks, let us call it the theta− (Applicant's choice).

At a constant energy/density of 355.5 GeV, the equivalent of a proton, the troton should exist (Applicant's choice), consisting of one bottom and two top quarks, and at 184.5 GeV, the equivalent of a neutron, the beutron (Applicant's choice), consisting of one top and two bottom quarks. The implications resulting from the conclusion that there are proton-like particles in the other two families are profound, when you consider what the effects would be if they were to interact, in a proton-like manner, with each other and with their neutron-like siblings, as we shall consider, in depth, later. The Applicant suggests that it is proper to consider a tripling of the periodic table of the elements.

### A Proof of Three Families by Simple Addition

Before his seminal work on the theory of the electron, Paul Dirac's first effort was an attempt to establish a fundamental connection between the microworld and the macroworld solely through the power of pure mathematical reasoning. Based upon a cosmological principle of his, the Large Number Hypothesis, he drew correlations between the very large numbers that represent the fundamental constants of nature in order to arrive at a new conclusion: that the gravitational constant “G” is inversely proportional to the age of the universe.

Controversial at the time, and still unproven, these ideas were never accepted by his peers. Nevertheless, Dirac continued to search for a theory of the microworld grounded on a “sound and beautiful” foundation. His theory aside, the quest still beckons.

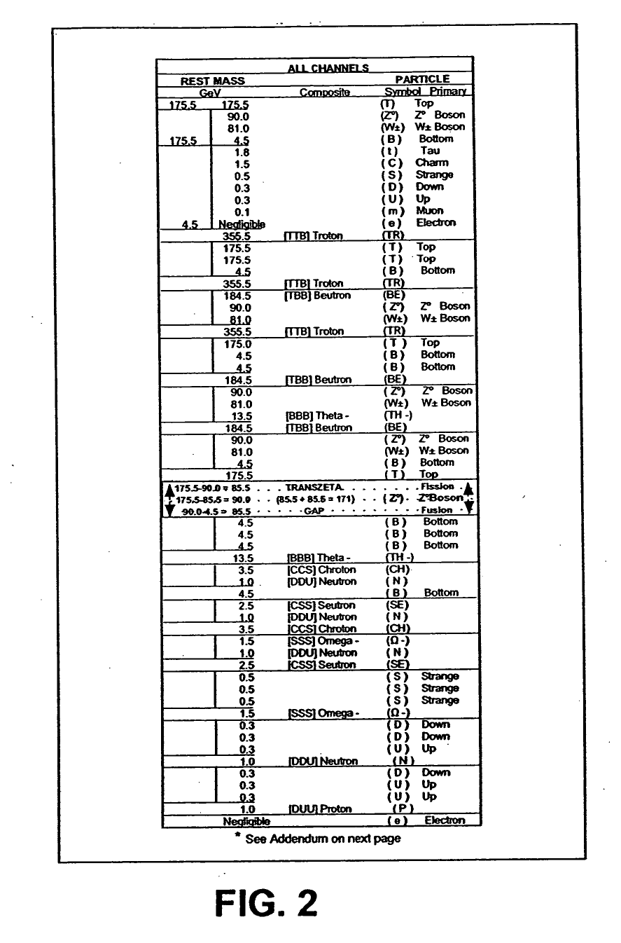

Let us now examine the relationships between the rest mass values of the known hadrons in the Standard Model. FIG. 2 lists the rest masses of all of the known fundamental particles in the Standard Model, and of those known composite particles which are important for our purposes, as well as of certain postulated composite particles. It is important to note that all the measured values of all of the known particles in the Standard Model are the averages of many measurements of each particle, in particle accelerator experiments, over extended periods. The greater the time that measurements have been taken of any particular particle usually means the time from when any specific particle was discovered, and this translates into more measurements and a greater accuracy of the measured value for that particle. Generally, the least massive particles have been the most accurately measured because they were discovered first and have been measured the most. Of equal importance, the more massive the particle, the shorter its lifetime, the more uncertain its mass, and the greater the number of potential particles, or channels, into which it can decay. For our purposes, please allow a variant of between ˜0.1 GeV, at the low end of a mass gradient, and 0.2 GeV, at the high end, to account for this degree of uncertainty.

We are also constrained by the conservation of electrical charge, which allows for the creation of massive particles out of pure energy, provided that electrical charge, one of the constituent properties of all matter, be equally balanced by plus (+) and minus (−) values whenever particles or energy are transformed from one into the other. Generally speaking, neutronic or antineutronic leptons balance these transformations.

It appears to be more than mathematical coincidence that the rest mass values of all of the known fundamental particles of the Standard Model (FIG. 2) total 355 GeV, which is equal to the rest mass of the troton (one bottom and two top quarks); that the rest mass of the troton (355.5 GeV) is equal to the sum of the rest masses of the beutron (184.5 GeV) plus the intermediate vector bosons (the Z⁰ at 90 GeV and the composite W± at 81 GeV=171 GeV; Applicant considers the W+ weak boson and the W− weak boson to be one composite particle with a single mass of 81 GeV, and a potential, but unexpressed, electromagnetic charge of zero, until such time as the W± interacts with a particlcle of matter, whereupon the charge becomes expressed as either plus one or minus one, depending upon the opposing charge of the interacting particle. The mass-to-charge association of the W± made a serendipitous appearance solely as a consequence of the proportional relationships between the masses set forth herein); that the rest mass of the beutron (184.5 GeV), with one top and two bottom quarks, equals the sum of the rest masses of the intermediate vector bosons (171 GeV) plus the theta− (13.5 GeV), with three bottom quarks; that the rest mass of the top quark (175.5 GeV) is equal to the sum of the rest masses of the bottom quark (4.5 GeV) plus the intermediate vector bosons (171 GeV); that the bottom quark (4.5 GeV) represents the sum of the rest masses of the chroton (3.5 GeV), with one strangle and two charm quarks and the neutron (1 GeV), with one up and two down quarks; that the rest mass of the chroton (3.5 GeV) equals the sum of the rest masses of the seutron (2.5 GeV), with one charm and two strange quarks plus the neutron (11 GeV); that the seutron (2.5 GeV) equals the sum of the rest masses of the omega− (1.5 GeV), with three strange quarks plus the neutron (1 GeV); (see also the “transzeta gap”; the seutron decay channel of the chroton; and the beutron decay channel of the troton, infra). The Applicant believes that this pattern of mathematical relationships is too “sound and beautiful” not to have been constructed upon a foundation of fundamental truths. See, Gary J. Feldman and Jack Steinberger, Scientific American,. February 1991, referring to the decay channels of the Z⁰ boson prior to the time when the rest mass value of the top quark was known, “The electroweak theory predicts the contributions of the known channels to an accuracy of about 1 percent, as follows: for the combined quark channels, 1.74 billion eV: . . . ”. This is in agreement with a rest mass value for the top quark at 175.5 GeV.

### The Relation of Mass and Electric Charge to Family Number

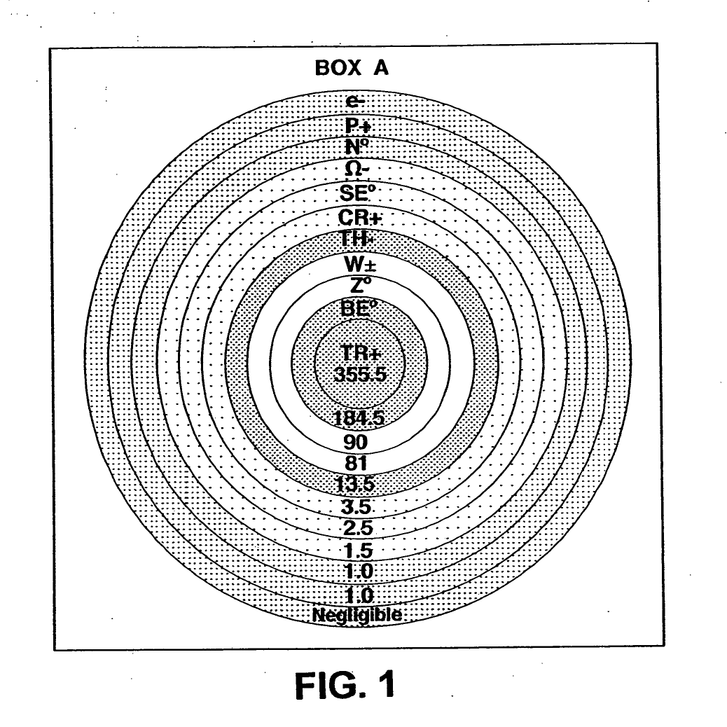

The massive sphere of matter/bosons, as it appears in FIG. 1, is composed of concentric circles that each represent the rest mass/energy value of a corresponding hadron or intermediate vector boson. Only massive particles which have a whole number charge of +1, −1, or 0 are included, with rest mass values rounded off to the nearest 0.2 GeV. Neutrinos are not included because their mass, if proven, would be so negligible as to not materially affect the results. Envision another sphere of antimatter that has similar but opposite electromagnetic charges, except for the weak bosons, which retain their charges in both spheres because weak bosons have no antimatter equivalent.

At the center of the illustrated sphere is the most massive and stable third family hadronic particle, the troton (or antitroton), which is composed of one bottom and two top quarks, with a rest mass of 355.5 GeV, and an electromagnetic charge of +1. The next, in descending mass, is the beutron, composed of one top and two bottom quarks, at 184.5 GeV, and a charge of 0.

The next more massive particles are not composite hadrons, but are intermediate vector bosons in particle mode, and are the fundamental particle carriers of the weak force, also known as weak bosons. The Z⁰ weak boson has a rest mass of 90 GeV and charge of 0, and the W± weak boson has a rest mass of 81 GeV and charge of either +1 or −1 (see note three).

The theta−, which is the analogue of the omega−, with three bottom quarks at 13.5 GeV and a charge of −1, brings us back to the hadrons, and terminates the third family of hadrons, with a total net charge of zero.

Enter the second family chroton, with one strange and two charm quarks, at 3.5 GeV and a charge of +1, followed by the seutron, with one charm and two strange quarks, at 2.5 GeV and a charge of 0. The omega−, with three strange quarks, at 1.5 GeV and −1 charge, terminates the second family of hadrons, with a total net charge of zero.

The first family neutron, at 1 GeV and 0 charge, is followed by the slightly less massive proton, at 1 GeV and +1 charge (and by the least massive baryon, the electron, a lepton, at 0.0005 GeV and −1 charge). They terminate the first family of hadrons (baryons) with a total net charge of zero.

You may ask, where are the second and third family leptons, the muon and the tauon? Although they cannot exist as particles at the extreme energy densities attendant to their respective family positions of rest mass within the sphere, their corresponding negative charges are conserved within the omega− (muon) and the theta− (tauon).

In the first family, there is no particle that is composed of three down quarks, with a −1 charge, which corresponds to the second family omega− or the third family theta−. Such a first family particle would be repelled by forces generated under Coulomb's law, which states that the force of repulsion or attraction between charges is proportional to the product of the charges and inversely proportional to the square of the distance between them. Yet the lepton electron, having a −1 charge and being necessary to construct earthly atoms and molecules, can independently survive on the periphery of the sphere, because it has so little mass that it exists beyond the range of energies which would destroy it. It is also protected from destruction while safely cocooned within the confines of the neutron.

Contrast the relatively massive muon and tauon leptons, which cannot support the creation of atomic/molecular structures because they cannot survive as stable massive particles at the energy densities of the second and third families. Yet they conserve their electric charges, like the grin of the Cheshire cat, in the omega− and the theta− particles, which do have the ability to participate in the creation of the analogue of neutral atoms, as we shall see.

### Top to Bottom

Now to the mediation role of the third family vis-a-vis our first family world. Conventional wisdom holds that present day first family matter gradually precipitated out of an energy/particle “soup”, which constituted the expanding fireball of the Big Bang. In that first microsecond, the energy was so intense that quarks roamed freely, until the energy dispersed and the fireball cooled, so that the free roaming up and down quarks could combine into protons and neutrons, it is said. It is also said that, a few hundred thousand years later, positively, charged protons then combined with negatively charged electrons to form the first neutral atoms, at which time radiation separated from matter, an event permanently imprinted upon the gradually cooling universal radiation background.

To play upon words, the Applicant refers to this process as the down-up model, and continuing the play on words, proposes the top-bottom model, which draws upon the findings of experimental particle accelerators, where massive proton/anti-proton pairs are directly created out of energetic collisional events, sans the intervention of separated quarks.

Contemplate the expanding Big Bang fireball, in thermal equilibrium. At the first instant of the expansion, radiation energy filled all of space, which was gravitationally curved in upon itself by the mutual attraction of the mass equivalence of that energy. The fireball was an expanding black hole that confined the radiation which, together with the momentum of the vacuum energy within space itself, drove the expansion.

At that first instant, all radiation energy existed at the highest frequency attainable by radiation, whatever that limit is (probably the fundamental value of a constant of nature). Since expansion is a cooling process, the frequency of that radiation diminished overtime, even as its wavelength increased. Yet, at any particular moment, all of the radiation which filled jail of space, equally at all points in space, was at the same frequency and wavelength.

At all relevant times subsequent to that first instant, radiation everywhere maintained itself at its lowest energetic state, a soliton. The soliton is a wave form that constantly retains its wavelength as it moves, because of some physical, coherent, and constant constraint upon its movement. The most common example of a soliton is a standing tidal wave, which maintains the height of its crest as it moves down an estuary because its retaining channel has a specific curvature and depth that correlates exactly to the specific height of the wave. The geometric curve of the channel and the energy originally imparted to the wave determine its form and wavelength.

So too, the curved geometry of space-time, within the expanding black hole of the fireball, constrained the radiation to take the form of a soliton wave. The wavelength of the soliton was maintained, at every point in space, at any particular instant, by the curved shape of the constraining black hole, even as space itself was expanding everywhere from each point in space-time. As the size of the expanding black hole increased smoothly with time, both the 1/0lume of space-time, and the wavelength of the universal background radiation, increased correspondingly. However, the wave form of the radiation remained that of a soliton, with incrementally distinct wavelengths that lengthened, from instant to instant, in a continuum, throughout the expanding fireball.

The density of the radiation, at that first instant of the expansion, was equal to the greatest density that radiation is permitted to attain and still be radiation, probably a constant of nature. The specific rest mass of any particle has an equivalent energy value, which, at a specific point on the energy/density gradient of the ambient energy background, will cause it to precipitate out as a particle, i.e.: it will spontaneously appear whenever the energy in the background attains the particular wavelength and density that corresponds to the equivalent rest mass of that particle.

It might be useful to think of a particle of matter as solid energy, “frozen” in solitonic form, with each specific particle at its own discrete energy level. This quantum mass/energy relationship is analogous to the quantum energy levels of the electronic shells which surround neutral atoms, except that the solitonic wave function of any particular hadron, quark, or lepton corresponds to its own quantum rest mass/energy level.

The stability of any particle, or antiparticle, depends upon it having a whole unit electromagnetic charge of +1, −1, or 0, and upon the maintenance of the background energy within the equivalent rest mass range of the family to which that particular particle is a member. The stable lepton has a charge of −1. In contrast, the ⅓ fractional charges of unstable quarks require them to triply combine into nucleons for stability. Mesonic couplings are unstable because of quark/antiquark interaction. If the energy background attains a value above or below the rest mass energy range corresponding to the family of any particular particle, the exposed particle will revert (decay) into its energy/wave equivalent. On the other hand, any specific particle will precipitate out of the energy background once the density of the energy equivalent of its specific rest mass is attained. The more massive the particle, the shorter its lifetime and the less specific that mass value will be, as a result of quantum uncertainty, but the mass will still lie within a range of potential energies called the mass band width, which has a peak average mass value and a corresponding mass uncertainty.

### The Emperor's Bose—First Light

Even if it is confirmed that there have always been only three families of matter, the energy of the entire fireball must have eventually cooled down, through expansion, to a uniform value of 355.5 GeV, the rest mass of the troton. From every point in space, and at the same time, fully formed trotons (and putative antitrotons) precipitated out of the universal background radiation, as opposed to the emergence of top and bottom quarks that later coalesced into trotons. The expanding sphere consisted of a contiguous ball of troton plasma.

At this instant, since the speed of sound in a gas did not exceed the speed of light for the first time, particles of matter could permanently form without being required to decay. This was also the period when matter quickly began to dominate antimatter. Actually, matter trotons and antimatter trotons should have spontaneously appeared in pairs (2×355.5 GeV) but antitrotons were forbidden to form because of two characteristics of intermediate vector bosons. The first has to do with the physical relationship between the rest masses of weak bosons and the energy range of the third family, and the second has to do with the nature of the mechanism by which weak boson particles mediate the transformations of other particles.

Current efforts to solve the mystery surrounding the dominance of matter over antimatter have concentrated on violations of symmetry within the Standard Model having to do with charge/parity reversal, or CP. However, total CP violation projected from the Standard Model is insufficient to account for the excess of matter in the universe. It also appears that the weak force violates CP.

In charge conjugation, or C, the quantum numbers of every particle are transposed into those of its antiparticle. If the laws of physics are the same in the real world as in the charge conjugated world, then C symmetry is achieved. If C symmetry has been achieved, then left handed charged particles should behave exactly as right handed charged particles. Therefore, charge symmetry is violated in weak interactions because anti neutrinos are only right handed, never left handed. Since antineutrinos interact only weakly with all other particles, this asymmetry is associated with the weak force. It appears that the weak force violates C.

In parity reversal, or P, when an object and its mirror reflection are rotated one hundred eighty degrees about their axis perpendicular to the mirror, parity reverses the vectors associated with the object. If the laws of physics are the same in the real world as in the parity reversed world, then P symmetry is achieved. If P symmetry has been achieved, then left handed particles would decay exactly as right handed particles. In a 1957 experiment, Chien-Shiung Wu, of Columbia University, demonstrated that only left handed particles can decay through the mediation of weak interactions, even though all neutrinos are right-handed, never left-handed. Since neutrinos interact only weakly with all other particles, this asymmetry is associated with the weak force. It appears that the weak force violates P.

Because the rest masses of the Z0 and Wt weak bosons (90 GeV-81 GeV) are “nested” entirely within the energy range of the third family of particles (355.5 GeV-3.5 GeV), it was necessary that the total amount of available radiant energy (2×355.5 GeV) of the expanding fireball be utilized in the production of not only the trotonic hadrons, but also of the intermediate vector bosons, at the same time.

Weak boson particles and matter particles differ in certain fundamental respects, but share similar characteristics in others. Quarks and leptons (matter) have half-unit integer spins (spin ½), in contrast to weak bosons (non-matter) which have whole-unit integer spins (spin 1). Bosons have electromagnetic charges of whole units (the Z⁰ charge 0, the W+ charge +1, tile W− charge −1, and the photon 0 charge). Leptons also have whole unit charges (the electron, the muon, and the tauon −1 charge each), and each lepton has an associated neutrino, 0 charge. Although quarks have fractional electromagnetic charges of +⅔ and −⅓, when three quarks combine into a hadron, the resulting hadron possesses the same whole unit electromagnetic charge as does a boson or a lepton (+1, −1, or 0).

Quarks and leptons obey Fermi statistics and are called Fermions. Matter particles consist entirely of Fermions. Fermions have an antiparticle equivalent. Weak boson particles obey Bose-Einstein statistics and are the carriers of the weak force. Weak bosons have no antiparticle equivalent. For example, there are antineutrons, but there are no antiZ⁰ bosons.

Despite their differences, it is apparent that Fermions and weak bosons are inherently connected in certain fundamental respects, if for no other reason than that they decay into one another. It is predicted in superstring theory that bosons and Fermions are unified at extreme energies. Weak bosons, quarks, and leptons are the only fundamental particles that exhibit mass in the Standard Model, and gravity acts equally upon each kind of massive particle.

Within the context of quantum mechanics, Bose-Einstein statistics allow whole unit integer spins of like particles to coalesce in such away, and under certain conditions, that they form a stable substance called a Bose-Einstein condensate. For such particles (e.g. alpha particles), which are stable only at first family rest mass/energy densities, those conditions are present only in a dilute gas, and only at temperatures approaching absolute zero. Bose-Einstein condensation has been demonstrated, under those specific conditions, because Bose-Einstein statistics permit identical weak bosons to attain a stable particle state when their deBroglie wave functions overlap.

It is the position of the Applicant that weak boson particles, having rest masses of 90 GeV-81 GeV, may also achieve stability, under other specific conditions which allow their deBroglie waves to overlap. Such conditions must have been present when weak bosons emerged from the expanding fireball, in quantum physical contact with each other and with stable third family nucleons, and while the weak bosons were nested within the constant rest mass/energy range of the third family (355.5 GeV-3.5 GeV).

Trotonic nucleons and weak boson particles, having emerged at the same time and at the same place, and within the same constant energy background, would have maintained physical contact between each other for the same reason that each attracts the other during observed nucleonic trans1′ormations, i.e. weak bosons are the carriers of the weak force. In this situation, quantum physical contact with a stable troton, beutron, or theta− should provide the necessary environment to stabilize a weak boson particle.

At energies above and below the specific rest mass energy range of the third family (355.5 GeV-3.5 GeV), weak bosons cannot transform from waves to particles. When not in particle mode, weak bosons mediate the radioactive decay of all other particles, including matter/antimatter transformations, within the diameter of a quark or a lepton, i.e. entirely within the confines of the interacting fundamental particles. Under those conditions, the transformations are exclusively determined by the constituent characteristics of the interacting particles only. One such characteristic requires the equal production of matter particles and antimatter particles to balance the transformations in all particle decay.

The Applicant proposes that, when a weak boson is in quantum physical contact with a stable third family hadron, which is bathed in the energy range of the third family, the particles merge, and the weak boson component attains a stable particle mode. The composite boson/Fermion particle, a bosion (Applicant's choice), thereby acquires stability, but it can then mediate radioactive decay only at the perimeter of the merged particle, because a weak boson particle may not occupy a physical position within any other kind of fundamental particle, such as the quark component of a hadron. That is, the stable weak boson particle component of a bosion is still capable of decay mediation, provided that quantum physical contact is maintained between the “perimeter” of the bosion and that of the transforming fundamental particle(s). Under those conditions, a bosion acts like a passive catalyst.

As a catalyst, a bosion can be considered a template upon which other particles interact, without the bosion actually participating in the interactions. The Applicant proposes that, as a catalyst, a bosion can only mediate those transformations that result in an end product that it, itself, is capable of attaining. Therefore, a stable weak boson particle, in bosion catalyst mode, is incapable of mediating the antimatter transformation of any other particle, because it, itself, lacks an antimatter component.

Although antitrotons were therefore prohibi1ted from forming, it is nevertheless mandatory that an equal, but oppositely charged, i3ntimatter component be created whenever matter is formed. Therefore, for every troton formed in the presence of a catalytic bosion, the Applicant proposes that an antineutronic lepton balanced the transformation. In this manner, two trotons of matter were created together with an antitauino, in lieu of a troton and an antitroton, so that total charge was conserved.

There are reasons why antitauinos are permitted during these transformations, and antitrotons are prohibited. Because weak boson particles do not operate within any other particle, including neutronic leptons, and because neutronic leptons, with or without mass, interact so weakly at the perimeters of all massive particles, including massive weak boson particles, the chance of a bosion mediating the transformation of a massless, or massive, antitauino is vanishingly small. As noted before, it also appears that the weak force violates the charge/parity reversal (CP) of neutronic leptons.

### A Bridge over Troubled Ethers

Also noted before, at a background energy of 355.5 GeV, trotons and other nucleons (but not anti nucleons) precipitated out of the radiation of the expanding fireball. Because the energy range of the weak bosons (90 GeV-81 GeV) lies entirely within the third family energy range (355.5 GeV-3.5 GeV), it is required that weak boson particles form at exactly the same time and place as third family trotons. Although fifty percent of the total energy (2×355.5 GeV) that would have been necessary to create one troton of matter, and one putative antitroton of antimatter, did actually produce one troton of matter (355.5 GeV), consisting of one 4.5 GeV bottom and two 175.5 GeV top quarks, the other fifty percent of the energy did not produce an antitroton, and instead produced one beutron of matter (184.5 GeV), consisting of one 175.5 GeV top and two 4.5 GeV bottom quarks, plus the weak bosons, cumulatively at 171 GeV (the 90 GeV Z⁰ and the 81 GeV W:!:). In this manner, total mass was conserved at 2×355.5 GeV and, in lieu of the putative antitroton and the putative antibottom quark, two antitauinos balanced the transformations.

Since the weak bosons were created at the same point in place and time as the Fermionic trotons and beutrons, each respective boson was attracted to a Fermion of opposite charge, and the bosion was born. The positively charged troton was bound to the expressed negative pole of the compound bipolar W±, the negatively charged theta− was bound to the expressed positive pole of the compound bipolar W±, and the neutral beutron was bound to the neutrally charged Z⁰ In this manner, the fireball was transformed from a charged trotonic plasma into a sphere of neutrally charged bosions. This was the era when matter permanently separated from radiation, and the fireball was no longer a “black” hole. The fire (radiation) had left the ball. That event has been imprinted on the universal background radiation to this day.

A neutrally charged bosion particle took shape (FIG. 1), which we shall call the weasion (711 GeV), consisting of a troton (35!5.5 GeV at +1 charge) in the center, surrounded by a beutron shell (184.5 GeV at 0 charge), which was then surrounded by a Z⁰ shell (90 GeV at 0 charge), and last by a W± shell (81 GeV with expressed −1 charge). The W−, being the least massive particle, had the longest wavelength, and was therefore still capable of mediating core troton interactions from the perimeter of the composite particle, because it maintained contact with the shortest wavelength troton, through the intervening particle shells, by quantum tunneling.

Bosions are a new class of neutrally charged composite particles (according to the Applicant), and they act as a bridge between the chaotic instabilities that were present in the era of matter/antimatter annihilation, and the stable matter era of the present. The other members of the class include the theasion, a negatively charged theta− bound to the positive pole of the W± component of the weasion (724.5 GeV); the treabion a neutral beutron and a positive trotor1 bound to the negative pole of the W± (621 GeV without the Z⁰); the theabion, a negatively charged theta− bound to the positive pole of the W± component of the treabion (634.5 GeV); the treawion , a positive troton bound to the negative pole of the W± (436.5 GeV without the beutron or the Z⁰); the theawion, a negatively charged theta− bound to the positive pole of the W± component of the treawion (450 GeV); the thearion, a neutral beutron and a negative theta− bound to the positive pole of the W± (279 GeV without the Z⁰); and the theation, a negative theta− bound to the expressed positive pole of the W± (94.5 GeV without the beutron or the Z⁰).

So long as it remains within the embrace 01′ some third family hadron, including that of the theta−, each bosion maintains its viability. The decay of any particular bosion is dependent upon the strength of the binding energy of its constituent weak boson(s), and each weak boson bound into a bosion is subject to becoming unbound at collisional or background er1ergies higher than the energy binding it to its respective bosion.

Bosions are the vehicles that transported our world of matter out of the matter/antimatter chaos of the maelstrom. They remain stable, some to this day (according to the Applicant), provided only that the binding energy of the weak boson component(s) of any particular bosion is not exceeded. This implies that, at the moment of bosion creation, the background radia1:ion was lower than such binding energy, and reinforces the proposition that all available background radiation, at that moment of intense energy, was subsumed in particle formation.

The breaking point of bosonic particle bonds probably lies within the energy range of the bottom quark, at the low end, because it must be more than 3.5 GeV, when the chroton would precipitate out of the background energy. It must also be less than 4.5 GeV, when the bottom quark would materialize out of a charm quark, combining with another charm quark and a strange quark to form an eta hybridon, the least massive hadron beyond the chroton.

It has been reported that the atmosphere of the Earth is being daily bombarded by mysterious point-like “cosmic ray” sources of rare, but immeasurably high, gamma rays. Each explosive event has been described as . . . “a proton with the impact of a well thrown rock”. Just imagine the effect of repeated collisions between a theasion (or other neutrally charged bosion) and the nucleons of the gas molecules within the Earth's atmosphere.

A theasion, for example, contains the mass of more than 750 protons and air molecules would add more nucleonic mass to the mix. Repeated collisions with molecules in the atmosphere would raise the temperature of the constituent weak boson particles above their binding energies. Once “unbound”, the weak bosons would lose their stability, and would then decay into particles of matter/antimatter. Unprotected from the constant background energy level of the first family, the remaining third family nucleons would promptly experience matter/antimatter decay in the presence of non-particle weak bosons which have no antimatter component. At the Earth's background energy, the non-catalytic weak force would mediate these decays, operating entirely within the diameters of the decaying particles. The decay products of matter and antimatter would then create the observed cascade of particles and energy which funnel down, and even burrow into, the surface.

One might ask, how could ancient and cosmologically distant theasions, or other bosions, survive to reach Earth at the present time? One reason is that bosions are electromagnetically neutral, and are therefore unaffected by the relatively weak magnetic fields of intergalactic space that might otherwise accelerate them to high collisional speeds, or that might guide them into collision with some electromagnetic source (a la aurora borealis).

Another reason is that their numbers have been diluted relative to the increased volume of space during the intervening billions of years of the expansion. Compared to the vast number originally created, relatively few bosions are observed to impact the Earth, partly because their numbers have been reduced by the cumulative effects of interstellar processes. Also, the more massive an interstellar bosion might be, the less numerous it must be, because it would have been that much more likely to have been gravitationally bound into, and then degraded within, a passing stellar core. This would explain why so few of the most energetic cosmic ray impacts in the atmosphere have been observed.

Although bosions may constitute super massive cosmic rays, they would have had to emanate from sources within the primordial stages of the expansion, and at extreme intergalactic distances relative to the present position of the Earth. Observations of high energy cosmic ray atmospheric collisions confirm that they are not creatures of local origin because they are omnidirectional and too energetic to be explained by galactic sources. Therein lies a conundrum, because it has been mathematically proven that collisions between cosmic rays and even the relatively weak primordial photons of the universal background radiation would dissipate the collisional energy of any cosmic ray, including that of a bosion.

Statistically, most intergalactic collisions must be glancing, and any isolated glancing impact would not be likely to break bosonic bonds before the heat of the collision were dissipated, even as it slowed the speed of the bosion. It is likely that deceleration caused by energy dissipation is a major reason for bosion longevity. For example, an isolated collision between a super massive, but sufficiently lethargic, bosion and, say, an intergalactic proton, would not necessarily be energetic enough to dislodge a weak boson from its matrix before the collisional energy were dissipated, even if the impact were head-on.

The solution to the puzzle is that most of the energy in observed atmospheric discharges, although precipitated by particle collisions, is generated not by the collisions themselves, but by boson decay and the resulting matter/antimatter disintegration of third family nucleons. To initiate boson decay, only the specific bosonic binding energy attendant to any particular bosion needs to be overcome. The fiery entry of meteoric dust particles in the atmosphere, through repeated collisions with air molecules, amply demonstrates the required energy to disintegrate a cosmic ray bosion. On a small scale, the effect would be like the detonation of an atomic bomb by a conventional explosive trigger.

### The Blastoma Phase

There was a brief time when particle birth roughly resembled initial biological cell division, with the emphasis on blast. That is, before particles were differentiated into the second and first families of matter, several varieties of third family/second family/bosion particles were formed. All of these new particles were created in quick succession, out of the same mass/energy source, and within a discrete volume of space, ergo the blastoma metaphor. It might be helpful to think of bosions as the generic “stem” particles from which all particles of the standard model evolved, i.e.: there is no primary or composite subzeta particle that is not a channel of bosion decay (FIG. 1 and FIG. 2).

As we have reasoned, the first particles of enduring matter to have precipitated out of the fireball were the bosions. At that time, the entire fireball was like an immense nucleus of uniform density, with each weasion physically touching another, and with no space or radiation existing between them. At that instant, the fireball was a homogeneous sphere, in thermal equilibrium. All weasions were equidistant from one another because there was insufficient time for gravity to squeeze them into a decay mode before the emergence of two sources of energy that resisted catastrophic collapse. The energy sources were boson decay, at first, and then nucleogenesis.

At that instant, there was little outward pressure to retard the inward crush of gravity, except for the expanding momentum of the vacuum energy of space itself which was insufficient to the task at that time. The Expansion continued to proceed equally from each local point in space and time, as it still does. However, each local point in space was then occupied, everywhere, by a contiguous particle of matter that was as equally massive as every other particl13 of matter. Therefore, the effect of gravity, everywhere, was to act instantly and simultaneously upon each local particle of mass, as it still does, in a graduated increase of attraction, in a seamless continuum, from the periphery of the sphere to its center.

The contemporaneous emergence of abutting weasions throughout the sphere immediately threatened gravitational collapse. However, due to the characteristics of the constituent particles of each weasion and their interactions, together with gravity, which was greater at the center than at the periphery, a nucleogenetic ballet began to unfold upon the cosmological stage.

At the very instant after the contraction, in the epicenter of the central region where the effect of gravity was the strongest, the binding energies of the weak bosons were quickly overcome, and the bosonic blonds broke. The weasions differentiated into their component parts. First the W±, and then the Z⁰ , once freed from their symbiotically stabilizing matrix nucleons (troton/beutron), became unstable and began to decay.

Two factors dominated the ensuing events: the relative values of the various binding energies of the involved particles, and their decay rates. The first particle to decay from the rest was the one with the smallest mass, and therefore the lowest binding energy, the W±. It is the outermost component of the weasion. The binding energy of the W, once released, bathed the contiguous and slightly more massive Z⁰ , causing it to decay in turn. The Z⁰ occupies the next most inward position within the weasion.

Although the matrix W± started to decay before the Z⁰ began its decay, because the latter is slightly more massive, it decayed slightly faster. Therefore, the Z⁰ began to decay before the matrix W± could complete its decay. During this time overlap, the decay products of both bosons were contemporaneously in situ, abutting the matrix nucleons, even as gravitational compression held them long enough to interact.

The decay channels of the matrix W± (81 GeV and charges +1 and −1=0) should have been three jets of theta-/antitheta+pairs (3 [2×13.5 GeV] and charges −1 and +1=0). The decay channels of the Z⁰ (90 GeV and 0 charge) are the W± (81 GeV and charges +1 and −1=0) and should have included a pair of bottom and antibottom quarks (2×4.5 GeV and charges +1 and −1=0). Total mass and charge would therefore have been conserved.

However, it must be kept in mind that the W± boson, which had been produced by Z⁰ decay had not yet itself decayed, and was still physically intact, at the same place when and where the matrix W± boson had just decayed into the triple pair of theta− (and putative antitheta−) particles, and when and where the bottom (and putative antibottom) quarks first appeared. The W± particle produced by Z⁰ decay was therefore still able to mediate, as; a catalyst, both the decays of the putative anti bottom quark and that of the three putative antitheta− particles. As a result, all six theta− particles and both bottom quarks were composed of matter only, and four antitauinos balanced the transformations.

Because quarks are stable only as triplets, pairs of bottom quarks are unstable and decay. Catalytic W± boson particle mediated the bottom quark decay (4.5 GeV=3.5 GeV +1.0 GeV), and its decay channels should have been chroton/putative antineutron and/or neutron/putative antichroton mesons, but only matter chrotons and matter neutrons were actually produced, with antineutronic leptons balancing the transformations. Chroton decay produced a seutron, a neutron, and a muino (3.5 GeV=2.5 GeV+1.0 GeV). Seutron decay produced an omega−, a proton, and an antimuino (2.5 GeV=1.5 GeV +1.0 GeV). The ambient energy background determined whether second family particles, or first family particles, or hybridons, or none of them, survived.

Minutes after their fiery passage, the limited lifetime of free roaming neutrons induced their decay, even if they survived the ambient energy background. Any neutrons that were created acted as cocoons that protected putative electrons from certain annihilation during their odyssey through the maelstrom. This is not to suggest that an electron maintains a physical presence inside of a neutron. Rather, it is the energy equivalence of an electron, that is incorporated into the mass of a neutron, which can be considered as potential electron mass, to be converted into physical electron mass, upon the ultimate decay of the neutron. Neutron decay that was mediated by non catalytic weak bosons released the fraternal triplets, a proton, an electron, and an antielectrino. In this very energetic environment, no particle could survive with a rest mass that was not within the energy range of the bottom quark (4.5 GeV−3.5 GeV).

One of the six negatively charged theta-particles attached itself to the positive pole of the catalytic W:!: boson, creating a theation. Another negatively charged theta− particle attached itself to the positively charged weasion matrix, creating a theasion.

As a proton is to a hydrogen ion (Hp), so a troton is to the ionic equivalent of third family hydrogen, i.e. trydrogen (Ht). Trotons and beutrons, having been created at the same point in place and time, interacted the way protons and neutrons interact. Free trotons and beutrons attached themselves to available theta minuses to create the neutral third family atomic analogue of isotopic deuterium, treuterium a/k/a treuteron. Here, the theta-mimics the first family electron, only within the nucleus. See also, atomic chreuterlum a/k/a chreuteron composed of a chroton, a seutron and an omega−, The electron/omega minus thela− relationship to hadron falmily atomic structure made a serendipitous appearance solely as a consequence of the relative proportions between the hadronic masses set forth above in A PROOF OF THREE FAMILIES BY SIMPLE ADDITION. The combination of a beutron (184.5 GeV) with ionic trydrogen (355.5 GeV), creates treuterium (540 GeV), and with two beutrons, creates ionic third family tritium, trydrogen three (724.5 GeV). The addition of a theta− (13.5 GeV) creates, respectively, atomic trydrogen, atomic treuterium, or atomic trydrogen three.

Yet, the primary third family hadron is still the troton, and an aggregation of individual trotons, uncombined with less massive beutrons or theta minuses in a compound hadron, remains the densest trotonic material. In other words, compound trotonic isotopes and atoms may be more massive than ionic trydrogen, but they are necessarily less dense.

The characteristics of the relationship between atomic hydrogen and its electron should be similar to that between atomic trydrogen and its theta−, except for the distance of each negative particle from its corresponding positive nucleon. If this be so, then trotonic atoms (and chrotonic atoms) shed their negatively charged components before, or during, fusion to higher trotonic (and chrotonic) elements. The products of the fission of atomic trydrogen (a troton and a theta− at 355.5 GeV+13.5 GeV=369 GeV), are two beutrons (184.5 GeV+184.5 GeV=369 GeV), where each top quark captures two of the four available bottom quarks. The neutron-like decay channels of second and third family proton-like hadrons made a serendipitous appearance solely as a consequence of the proponional relationships between the hadronlc masses set tanh above in A PROOF OF THREE FAMILIES BY SIMPLE ADDITION.

There is a contrasting, but compensating, difference between third family and first family nucleosynthesis. On the one hand, atomic trydrogen, being more massive than ionic hydrogen, requires more energy, in absolute terms, to initiate fusion. On the other hand, electromagnetically neutral third family atomic nuclei fuse at comparatively lower energies than do positively charged hydrogen ions, because they do not repel one another.

One skilled in the art of particle accelerator particle generation would understand that the operation of a particle accelerator to generate the above-mentioned particles would have many possible applications, including, but not limited to providing an antimatter/particle fuel cascade.

A particle accelerator can be finely tuned to operate at the discrete energies attendant to the creation of bosions. A preferred method of tuning a particle accelerator is to employ the beam of the particle accelerator to produce nuclear reactions that occur at known, accurately measured energies. Nuclear spectroscopists have compiled extensive tables of energy levels in nuclei. Certain levels demonstrate resonance behavior where reaction products (i.e., gamma rays or particles) are emitted in large numbers only within a very narrow range of incident particle energies. An example of such a reaction is ²⁷Al+p→²⁸Si*. In this reaction, the ²⁸Si nucleus, having been excited by protons, subsequently emits gamma radiation. This reaction excites many energy states. However, the energy of the radiation is determined by the energy state to which the ²⁸Si atom has been excited. Studies have verified the existence of an isolated, well-defined resonance for this reaction as an incident proton energy of 991.88 keV and this resonance is a widely accepted calibration energy. See, e.g., Kelly article (supra.) Using this ²⁷Al+p→²⁸Si* reaction, a particle accelerator is calibrated by using the accelerator to direct protons to an ²⁷Al target. The energy of the resulting gamma radiation is measured. The energy level of the accelerator is adjusted and the process is repeated until gamma radiation having an energy level equivalent to an incident proton energy of 991.88 keV is produced.

Thus, similar to calibration using the ²⁷Al+p→²⁸Si* reaction, in a preferred embodiment of the present invention, the particle accelerator is tuned by using the particle accelerator to generate a first nuclear reaction. This nuclear reaction produces a first set of reaction products whose energy is measured. If the energy of the first set of reaction products is not equivalent to the discrete energy level attendant to the creation of neutrally charged stable compound particles, then, the accelerator is adjusted (to a higher or lower energy level, depending on the initial measurement) and the particle accelerator generates a second nuclear reaction and the energy of the resulting second set of reaction products is measured. The process is repeated until the desired energy level (i.e., the energy level attendant to the creation of neutrally charged stable compound particles) is reached.

Although the invention has been described with reference to preferred embodiments, it will be appreciated by one of ordinary skill in the art that numerous modifications are possible in light of the above disclosure.

1. A method for generating neutrally charged stable compound particles employing a particle accelerator, the method comprising:
tuning the particle accelerator to operate at a discrete energy level attendant to the creation of neutrally charged stable compound particles, the tuning step comprising,
using the particle accelerator to generate at least one nuclear reaction, wherein the at least one nuclear reaction produces the at least one set of reaction products,
measuring the energy of the at least one set of reaction products, wherein each said compound particle consists of
a hadron of the third family of matter, and
an intermediate vector boson particle, and further;
wherein each said compound particle is created at the combined energies which sum to the equivalent rest masses of the interacting particles plus or minus 1 GeV.

2. A method for generating neutrally charged stable particles according to claim 1, comprising the further step of capturing and storing said compound particles to provide an antimatter/particle cascade fuel.

3. A method for generating neutrally charged stable particles according to claim 2, comprising the further step of attaching said compound particles to positive ions for use in particle accelerator applications.

4. At least one of a class of neutrally charged stable compound particles, each said compound particle comprising:
a hadron of the third family of matter, and
an intermediate vector boson particle,
wherein each said compound particle is created at the combined energies which sum to the equivalent rest masses of the interacting particles plus or minus 1 GeV.
